(19) United States
(12) Patent Application Publication
(10) Pub. No.: US 2004/0230968 A1
(43) Pub. Date: Nov. 18, 2004

(54) Management system of relays for network apparatus, relay for network apparatus, authentication server, updating server, and method of managing relays for network apparatus

(75) Inventors: Shinya Masunaga, Tokyo (JP); Takahiro Fujimori, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/795,261

(22) Filed: Mar. 9, 2004

(30) Foreign Application Priority Data
Mar. 11, 2003 (JP) 2003-065162

(51) Int. Cl. H04L 12/28; G06F 9/44

(52) U.S. Cl. 717/171

(57) ABSTRACT

Disclosed herein is a management system to manage relays for network apparatus in which firmware of the relays can be updated without involving external apparatus, wherein: the router management system comprises: a plurality of AV routers, each AV router having a unique identification number, provided with firmware for prescribed control, having one or a plurality of network apparatus connected to it, and connecting the network apparatus to the network; an authentication server to authenticate the AV routers by checking their identification numbers through the network; and an updating server to provide the authenticated AV routers with an updated file of the firmware through the network. The AV routers access the updating server automatically to ascertain whether there is an updated file of the firmware in the updating server or not.

### BACKGROUND OF THE INVENTION

1. Field of the Invention

This invention relates to a relay to connect network apparatus such as computers (PC) and game apparatus to a network. More specifically, this invention is characterized by the management of firmware to be installed in the relay. This invention relates to a management system of relays for network apparatus, a relay for network apparatus, an authentication server, an updating server, and a method of managing relays for network apparatus.

2. Prior Art

The router is to connect LANs (local area networks) to a WAN (wide area network) or connect LANs together. The router makes packet-relaying processing in the network layer of an OSI (open systems interconnection) base reference model. The router controls routes by referring to IP (Internet protocol) addresses in a TCP/IP network. Data can be transmitted only between adjacent nodes or only on one and the same segment in a data-link layer, whereas the router combines data-transmission functions in a data-link layer and transmits data among all the nodes on a network.

Firmware is used for the OS's of routers, BIOS control programs, etc. Firmware is software stored in ROMs, etc. built in apparatus and placed between hardware and software. Because processing speed can be increased by realizing the functions of software with firmware using microprograms, software which is changed relatively less frequently are being replaced by firmware. Firmware is generally stored in rewritable storage media such as flash memories; accordingly, functions can be added and programs can be revised later on.

Firmware to be installed in routers must allow the addition of functions and the revision of programs. Besides, it must allow updating at any time, for example, for the purpose of providing only members with additional services. The updating of firmware of routers has so far been made by external processing devices such as computers. More specifically, the user of a computer connected to a router accesses a server (updating server) holding an updated file, downloads the updated file into his computer, and uploads the updated file from his computer into the router (Refer to, for example, non-patent references 1 to 3).

[Non-patent reference 1]

Information about Yamaha RT-Series Routers/Firmware http://www.rtpro.yamaha.co.jp/RT/FAQ/Install/revisio n-up.html

[Non-patent reference 2]

corega K. K./Firmware Up Data, Download http://www.corega.co.jp/support/download/wl wlapl11. htm

[Non-patent reference 3]

Melco, Inc./Download Service http://buffalo.melcoinc.co.jp/download/driver/lan/bl r-tx4.html

### SUMMARY OF THE INVENTION

With the above prior art, an updated file has to be downloaded into a computer through a router and then the downloaded updated file has to be uploaded into the router. Accordingly, the updating of firmware is not easy work for users inexperienced in using computers. More importantly, users may fail to update the firmware because their computers are not always running. Updating to solve a serious problem in particular has to be made in real time.

In view of the above problems of relays for network apparatus in accordance with the prior art, the main object of the present invention is to provide a management system of relays for network apparatus, a relay for network apparatus, an authentication server, an updating server, and a method of managing relays for network apparatus which are new and improved and enable users to update the firmware of relays without downloading an updated file into their computers.

Another object of the present invention is to provide a management system of relays for network apparatus, a relay for network apparatus, an authentication server, an updating server, and a method of managing relays for network apparatus which are new and improved and capable of updating the firmware of relays in real time.

A first aspect of the present invention is directed to a management system to manage relays for connecting network apparatus to a network. The system comprises:

a plurality of relays, each relay having a unique identification number, provided with firmware for prescribed control,having one or a plurality of network apparatus connected to it, and connecting said network apparatus to said network;

an authentication server to authenticate the relays by checking their identification numbers through the network; and

an updating server to provide the authenticated relays with an updated file of the firmware through the network.

The relays access the updating server automatically to ascertain whether there is an updated file of the firmware in the updating server or not.

With the above configuration of the management system, because each relay has a unique ID number, each relay can cooperate with the authentication and updating servers for its authentication and the updating of its firmware without involving an external device such as a computer in the processing. Unlike the prior art, it is not necessary for the user to download an updated file into his computer through a relay and then upload the updated file from his computer into the relay. Accordingly, even inexperienced users can easily update the firmware of relays.

Besides, as the relay accesses to the updating server automatically to ascertain whether there is an updated file of the firmware in the updating server or not, the firmware of the relay is updated in real time if the power of the relay is always kept on; thus, the firmware is always kept in the newest condition.

A second aspect of the present invention is directed to a management system to manage relays for connecting network apparatus to a network. The system comprises:

a plurality of relays, each relay having a unique identification number, provided with firmware for prescribed control, having one or a plurality of network apparatus connected to it, and connecting said network apparatus to said network; and

an updating server to authenticate the relays by checking their identification numbers through the network and provide the authenticated relays with an updated file of the firmware through the network.

The relays access the updating server automatically to ascertain whether there is an updated file of the firmware in the updating server or not.

With the above configuration of the management system, because each relay has a unique ID number, each relay can cooperate with the updating server for its authentication and the updating of its firmware without involving an external device such as a computer in the processing. Unlike the prior art, it is not necessary for the user to download an updated file into his computer through a relay and then upload the updated file from his computer into the relay. Accordingly, even inexperienced users can easily update the firmware of relays.

Besides, as the relay accesses to the updating server automatically to ascertain whether there is an updated file of the firmware in the updating server or not, the firmware of the relay is updated in real time if the power of the relay is always kept on; thus, the firmware is always kept in the newest condition.

A third aspect of the present invention is directed to a relay having one or a plurality of network apparatus connected to it and connecting said network apparatus to a network. The relay comprises:

a storage unit wherein a unique identification number of the relay and firmware for prescribed control is stored;

a control unit to do the prescribed control by running the firmware;

a transmitting unit to transmit the identification number of the relay through said network for the authentication of the relay; and

a receiving unit to receive an updated file of the firmware through the network after the authentication of the relay.

With the above configuration of the relay, because the relay has a unique ID number, it can cooperate with a server or servers for authentication and updating without involving an external device such as a computer in the processing of authentication and updating. Unlike the prior art, it is not necessary for the user to download an updated file into his computer through a relay and then upload the updated file from his computer into the relay. Accordingly, even inexperienced users can easily update the firmware of relays.

The above relay in accordance with the third aspect of the present invention has the following application.

The control unit of the relay may be designed so that it will access an updating server automatically to ascertain whether there is an updated file in the updating server or not. In this case, the firmware of the relay is updated in real time if the power of the relay is always kept on; thus, the firmware is always kept in the newest condition.

If relays are constructed so that they will automatically access an updating server as described above, the updating server may be overloaded. To avoid the overloading of the updating server, the control units of relays may be provided with a time-managing function. With the time-managing function, times of many relays' access to the updating server can be dispersed; thus, the load on the updating server is reduced. Besides, as the scale of the updating server can be reduced, the burden of maintenance of the system is reduced.

The control unit of the relay may be designed so that it will access an authentication server for the authentication of the relay. With this control unit of the relay, an updated file can be sent to only authenticated relays; therefore, the security of the system is improved. Besides, the system can be operated in various ways such as providing specific relays with specific services.

The control unit of the relay may be provided with the function of encoding the ID number of the relay and transmitting the encoded ID number. Such encoding can be made by using the public key system or the secret key system (common key system). The security of the system is improved because the ID number can be encoded and then transmitted by using such technique.

The storage area of the above storage unit may include a first area wherein the updated file of the firmware received at the last updating is stored and a second area wherein an updated file before the updated file stored in the first area is stored. While the firmware in the first area is being updated, it may be damaged because of, for example, power failure due to some cause. If it happens, the second area enables the relay to recover easily.

If the above relay is provided with a display unit to show various kinds of information and an operating unit for the user to operate the relay, the user can operate the relay easily.

If the above relay is provided with a slot to hold a removable means of memory, the scope of application of the relay widens. Memory Stick (registered trademark) is an example of the removable means of memory. Memory Stick is a kind of memory card standardized by Sony Corporation and characterized by its slender shape like a stick of chewing gum and its small contact area. Memory Stick in combination with an adapter can be used as a flash-memory card, and devices compatible with the flash-memory card are being put on the market in various fields such as notebook PCs, PDAs (personal digital assistants), digital cameras, digital video cameras, silicon audio, portable telephones, and car navigation.

Audio and video files of various formats can be stored in a Memory Stick. Besides, two or more apparatus (computers, game apparatus, etc.) connected to the relay can share the files stored in the Memory Stick. Moreover, the data of a Web site can be stored in the Memory Stick and the Web site can be opened to the public. Text files, files of static and dynamic images, audio files, etc. can be prepared as the data of Web sites by using such devices compatible with the Memory Stick as notebook PCs, PDAs, digital cameras, and digital video cameras.

A fourth aspect of the present invention is directed to an authentication server which authenticates relays with unique identification numbers by checking the identification numbers, each relay having firmware for prescribed control and one or a plurality of network apparatus connected to it, connecting said network apparatus to a network, and transmitting its identification number to the authentication server for authentication.

With the above authentication server, relays can transmit their ID numbers directly to the authentication server for authentication without involving external devices such as computers in the processing of transmission and authentication. Accordingly, the firmware of relays can be updated without involving external devices such as computers in the updating processing. Accordingly, unlike the prior art, it is not necessary for the user to download an updated file into his computer through a relay and then upload the updated file from his computer into the relay. Accordingly, even inexperienced users can easily update the firmware of relays.

The above authentication server in accordance with the fourth aspect of the present invention has the following application.

The authentication server may be provided with the function of issuing a password for the authenticated relays to demand an updated file of the firmware from an updating server after authenticating the relays. The authenticated relays use the password when they demand an updated file from the updating server; therefore, the updating server can send an updated file to only the authenticated relays.

The password may be a one-time password. A one-time, or throwaway, or dynamic, password can be used only once. Even if a one-time password leaks out to a third party, damage would be minimal because it cannot be used repeatedly.

The authentication server may be provided with the function of encoding the password and transmitting the encoded password. Such encoding can be made by using the public key system or the secret key system (common key system). Thus, the security of the system is improved.

In order to improve the security of the system, the updating server may send the authentication server an inquiry about whether the authentication server authenticated the relays or not and the authentication server may send a reply to the updating server.

A fifth aspect of the present invention is directed to an updating server which provides relays with an updated file of their firmware though a network after an authentication server authenticates the relays by checking their identification numbers, each relay having a unique identification number, firmware for prescribed control, and one or a plurality of network apparatus connected to it and connecting said network apparatus to the network.

With the above configuration of the updating server, the relays send demands for updating directly to the updating server and their firmware is updated without involving external devices such as computers in the updating processing. Unlike the prior art, it is not necessary for the user to download an updated file into his computer through a relay and then upload the updated file from his computer into the relay. Accordingly, even inexperienced users can easily update the firmware of relays.

The above updating server in accordance with the fifth aspect of the present invention has the following application.

The updating server may be provided with the function of encoding the updated file and transmitting the encoded updated file through the network. Such encoding can be made by using the public key system or the secret key system (common key system) Thus, the security of the system is improved.

The updating server may provide the network apparatus, too, with the updated file of the firmware. In this case, the format of the updated file held by the relays is the same as the format of the updated file held by the network apparatus.

To improve the security of the system, the updating server may send the authentication server an inquiry about whether the authentication server authenticated the relays or not.

Because all the users of the relays do not necessarily need the updating of the firmware, the updating server may inquire of the relays accessing the server whether the relays need the updated file or not.

A sixth aspect of the present invention is directed to an updating server which (i) authenticates relays with unique identification numbers by checking the identification numbers, each relay having firmware for prescribed control and one or a plurality of network apparatus connected to it, connecting said network apparatus to a network, and transmitting its identification number to the updating server for authentication, and (ii) provides the authenticated relays with an updated file of the firmware though the network.

With the above configuration of the updating server, the relays send demands for updating directly to the updating server and their firmware is updated without involving external devices such as computers in the updating processing. Unlike the prior art, it is not necessary for the user to download an updated file into his computer through a relay and then upload the updated file from his computer into the relay. Accordingly, even inexperienced users can easily update the firmware of relays.

The above updating server in accordance with the sixth aspect of the present invention has the following application.

The updating server may be provided with the function of encoding the updated file and sending the encoded updated file through the network. Such encoding can be made by using the public key system or the secret key system (common key system) Thus, the security of the system is improved.

The updating server may provide the network apparatus, too, with the updated file of the firmware. In this case, the format of the updated file held by the relays is the same as the format of the updated file held by the network apparatus.

Because all the users of the relays do not necessarily need the updating of the firmware, the updating server may inquire of the relays accessing the server whether the relays need the updated file or not.

The communication among the above relays and authentication and updating servers may be encoded. Such encoding can be made by using SSL (Secure Sockets Layer) technique. SSL is technique to secure the data exchanged between WWW browsers and WWW servers and a protocol to realize encoding and authenticating functions in the socket level. Wire tapping can be prevented by ascertaining that the WWW server on the other side is authentic and by encoding data before transmission.

A seventh aspect of the present invention is directed to a method of managing relays. This method is compatible with the management system in accordance with, for example, the first aspect of the present invention and comprises:

a first step wherein relays access an updating server to ascertain whether there is an updated file of their firmware in the updating server or not;

a second step wherein if the relays need an updated file, they demand authentication from an authentication server;

a third step wherein the authentication server authenticates the relays and issues a password to them;

a fourth step wherein the relays demand the updated file from the updating server by using the password; and

a fifth step wherein the updating server checks to see that the password is correct and sends the updated file to the relays.

The above method of managing relays in accordance with the seventh aspect of the present invention has the following application.

An automatically updating mode and a manually updating mode may be made available. In this case, in the above first step, the relays (i) ascertain whether the updating mode of the firmware is automatic or manual, (ii) find whether or not it is time to ascertain the presence or absence of an updated file if the updating mode is automatic, and (iii) access the updating server if it is time to ascertain the presence or absence of an updated file or if the updating mode is manual and they are to ascertain immediately whether there is an updated file in the updating server or not.

Because all the users of the relays do not necessarily need the updating of the firmware, the updating server may inquire of the users of relays accessing the server whether they need the updated file or not. In this case, the above second step includes a sub-step wherein if there is an updated file in the updating server, the updating server inquires of the relays accessing it whether they need the updated file or not.

An eighth aspect of the present invention is directed to a method of managing relays. This method is compatible with the management system in accordance with, for example, the second aspect of the present invention and comprises:

a first step wherein relays access an updating server to ascertain whether there is an updated file of their firmware in the updating server or not; and

a second step wherein the updating server authenticates the relays and sends the updated file to the relays.

The above method of managing relays in accordance with the eighth aspect of the present invention has the following application.

An automatically updating mode and a manually updating mode may be made available. In this case, in the above first step, the relays (i) ascertain whether the updating mode of the firmware is automatic or manual, (ii) find whether or not it is time to ascertain the presence or absence of an updated file if the updating mode is automatic, and (iii) access the updating server if it is time to ascertain the presence or absence of an updated file or if the updating mode is manual and they are to ascertain immediately whether there is an updated file in the updating server or not.

Because all the users of relays do not necessarily need the updating of the firmware, the updating server may inquire of the users of relays accessing the server whether they need the updated file or not. In this case, the above second step includes a sub-step wherein if there is an updated file in the updating server, the updating server inquires of the relays accessing it whether they need the updated file or not.

As described above, according to the present invention, because each relay connecting the network apparatus and the network has a unique ID number, each relay can cooperate with the authentication and updating servers for its authentication and the updating of its firmware without involving an external device such as a computer in the processing. Therefore, unlike the prior art, it is not necessary for the user to download an updated file into his computer through the relay and then upload the updated file from his computer into the relay. Accordingly, even inexperienced users can easily update the firmware of the relays. Besides, the firmware of the relay can be updated in real time if the power of the relay is always kept on; thus the firmware is always kept in the newest condition.

### BRIEF DESCRIPTION OF THE DRAWINGS

FIG. 1 is an illustration of the management system according to the first embodiment;

FIG. 2 is an illustration showing an outward appearance of the AV router 100;

FIGS. 3A to 3C are illustrations of the display unit of the AV router 100;

FIG. 4 is an illustration of the back of the case of the AV router 100;

FIG. 5 is a block diagram showing the internal structure of the AV router 100;

FIG. 6 is an illustration of the storage area of the storage unit;

FIG. 7 is an illustration of the concept of an updated file of the firmware;

FIG. 8 is an illustration of the communication among components;

FIG. 9 is a flowchart of the router management method according to the first embodiment;

FIG. 10 is a flowchart showing the details of Step S106 of FIG. 9;

FIG. 11 is an illustration of the router management system according to the second embodiments;

FIG. 12 is an illustration of the communication between components; and

FIG. 13 is a flowchart showing the details of Step S106 of FIG. 9.

### DESCRIPTION OF THE PREFERRED EMBODIMENTS

Referring to the accompanying drawings, preferable embodiments of a management system of relays for network apparatus, a relay for network apparatus, an authentication server, an updating server, and a method of managing relays for network apparatus in accordance with the present invention will be described in detail. The repetitive description is avoided by allotting the same reference numbers to components with substantially the same construction and functions in this specification and the accompanying drawings.

(First Embodiment)

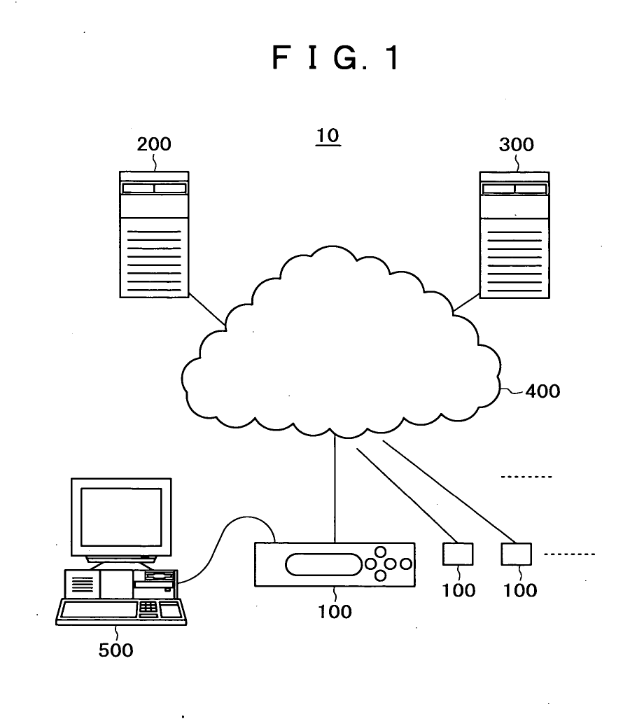

Referring to FIGS. 1 to 7, the management system of relays for network apparatus of the first embodiment will be described below. Relays to be managed in this embodiment are AV routers 100 which are used to change routes of AV (Audio-Video) signals in offices and homes, and the management system of this embodiment is hereinafter referred to as “router management system.”

As shown in FIG. 1, the router management system 10 of this embodiment comprises AV routers 100, an authentication server 200 to authenticate the AV routers 100, and an updating server 300 to provide an updated file of firmware installed in the AV routers 100, and these routers and servers are connected to one another through a network 400. The network 400 is assumed to be the Internet to be connected to through public switched networks. In this embodiment, network apparatus connected to the AV routers 100 are computers 500. “Net work apparatus” here is the generic name of devices which are connected to the network 400 and operate or are operated through the network 400. The network apparatus may be household electrical appliances such as game apparatus, video decks, and video cameras for monitoring. Although one authentication server 200 and one updating server 300 are shown in FIG. 1, a plurality of authentication servers 200 and a plurality of updating servers 300 may be connected to the network 400. The AV routers 100 are to be installed in homes and offices and a very large number (for example, tens of thousands) of AV routers 100 are connected to the network 400.

(AV Routers 100)

AV routers 100 are an example of relays to be managed by the router management system 10. The AV router 100 may be 204 mm (width) by 231 (depth) by 45 (height) and about 1.3 kg and installed in a home or office. As shown in FIG. 1, a computer 500 can be connected to an AV router 100. A plurality of computers 500 may be connected to an AV router 100 to form a LAN (local area network). Besides, game apparatus for playing games through networks can be connected to AV routers 100. Thus, AV routers 100 function as relays to connect computers 500 and game apparatus to a network 400.

(Structure of AV Router 100)

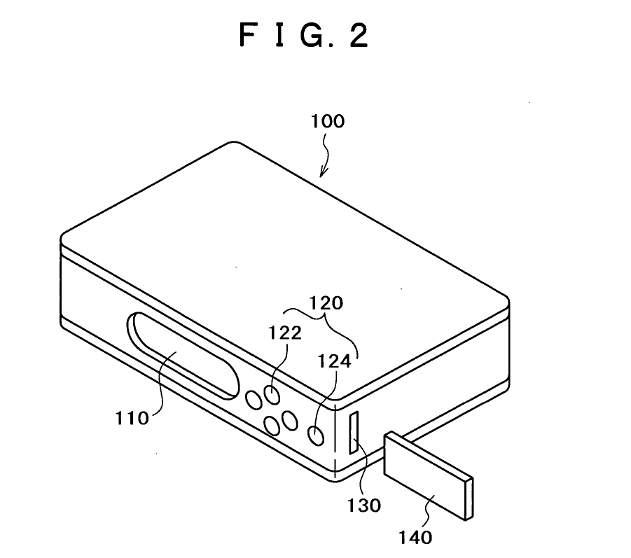

FIG. 2 is an illustration of the AV router 100 according to the present embodiment. As shown in FIG. 2, the AV router 100 has a display unit 110 and an operating unit 120 on the front of its case. The AV router 100 has a slot 130 on a side of its case, too, to hold a memory card 140, an example of removable storage. Besides, provided on the back of the case of the AV router 100 are various interfaces for the connection of network apparatus such as computers and game apparatus (to be described later with reference to FIG. 4).

(Front of Case of AV Router 100)

The front of the case of the AV router 100 will first be described. Provided on the front of the case of the AV router 100 are the display unit 110 to show set information and various kinds of other information and the operating unit 120 for the user to operate the AV router 100. The operating unit 120 comprises cursor keys 122 to move the cursor up, down, right, and left in the display unit 110 and an enter key 124 to execute an instruction. The display unit 110 comprises, for example, a liquid crystal display.

(Display Unit 110)

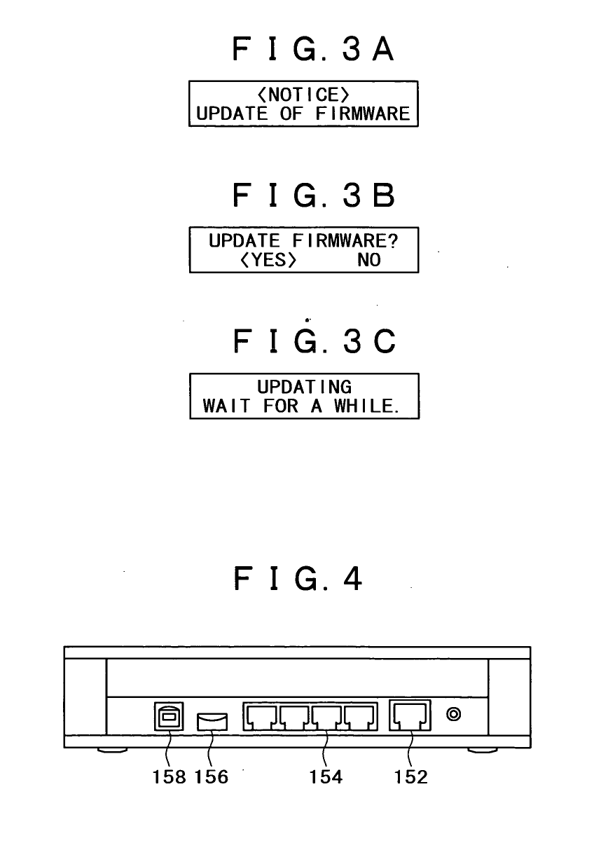

With reference to FIGS. 3A to 3C, various kinds of information shown at the display unit 110 and various kinds of operation at the operating unit 120 will be described below. Out of such various kinds of information, information about the update of the firmware immediately after turning on the power of the AV router 100 is shown in FIGS. 3(a), (b), and (c).

When the power of the AV router 100 is turned on, the AV router 100 boots automatically (Auto Boot-up) and a message of “Notice: update of firmware” is shown as in FIG. 3A, notifying the user of the necessity of updating the firmware.

Then, a message of “Do you update the firmware? Yes or No” is shown as in FIG. 3A, asking the user whether to update the firmware or not. The user chooses “Yes” or “No,” by using the cursor keys 122 of the operating unit 120. Then, the user executes his instruction with the enter key 124.

If the user chooses “Yes” and executes the instruction, a message of “Updating. Wait for a while” is shown as in FIG. 3C. Thus, the AV router 100 updates its firmware.

Apart from the messages shown in FIGS. 3(a), (b), and (c), the display unit 110 can show any such information in any forms as information about the date and time, information about networks such as IP addresses, information about the version of firmware, information about the setting of brightness of the display unit 110, and information about the ID and passwords. The operating unit 120 may be of a dial type or a touch-panel type instead of the key type shown in FIG. 2.

Some of the network apparatus connected to AV routers 100 have displays (display units). If a computer with a display is connected to an AV router 100, the information shown on the display unit 110 can be shown on the display of the computer, too. In this case, the user of the computer can monitor the settings and condition of the AV router 100 through the display of the computer, too, and various settings of an AV router 100 can be made by using not only its display unit 110 and operating unit 120 as described above but also a computer or game apparatus connected to the AV router 100.

(Side of Case of AV Router 100)

As shown in FIG. 2, provided on a side of the case of the AV router 100 is a slot 130 to hold a memory card 140, an example of removable storage. Memory Stick (registered trademark) is an example of memory cards 140. Memory Stick is a kind of memory card 140 standardized by Sony Corporation and characterized by its slender shape like a stick of chewing gum and its small contact area. Memory Stick in combination with an adapter can be used as a flash-memory card, and devices compatible with the flash-memory card are being put on the market in various fields such as notebook PCs, PDAs (personal digital assistants), digital cameras, digital video cameras, silicon audio, portable telephones, and car navigation.

Audio and video files of various formats can be stored in the memory card 140. Besides, two or more apparatus (computers, game apparatus, etc.) connected to an AV router 100 can share the files stored in a memory card 140 inserted into the slot 130 of the AV router 100. Moreover, the data of a Web site can be stored in a memory card 140 inserted into the slot 130 of an AV router 100 and the Web site can be opened to the public. Text files, files of static and dynamic images, audio files, etc. can be prepared as the data of Web sites by using various devices compatible with the memory card 140 such as notebook PCs, PDAs, digital cameras, and digital video cameras.

(Back of Case of AV Router 100)

With reference to FIG. 4, the back of the case of the AV router 100 will be described below. Provided on the back of the case of the AV router 100 are a power switch, interfaces for the connection to various devices, and so on as shown in FIG. 4. The interfaces are one 10BASE-T/100BASE-TX as a WAN-side port 152, four 10BASE-T/100BASE-TX as LAN-side ports 154, a flat-shaped USB port 156, and a square USB port 158.

Various network apparatus to be connected to the network 400 can be connected to AV routers 100 through the interfaces on their backs. For example, one or a plurality of computers can be connected to AV routers 100 to form a LAN. Besides, game apparatus compatible with the Internet can be connected to AV routers 100. Moreover, with AV routers 100, wireless LANs can be formed. Furthermore, peripheral devices such as hard disk drives can be connected to AV routers 100. The AV router 100 conforms to IEEE 802.11b and is capable of wireless LAN communication at 11 Mbps at the maximum. With a wireless LAN, WEP (Wired Equivalent Privacy) of 64/128 bits can be set. With a wired LAN, throughput up to 93 Mbps can be realized.

(Internal Structure of AV Router 100)

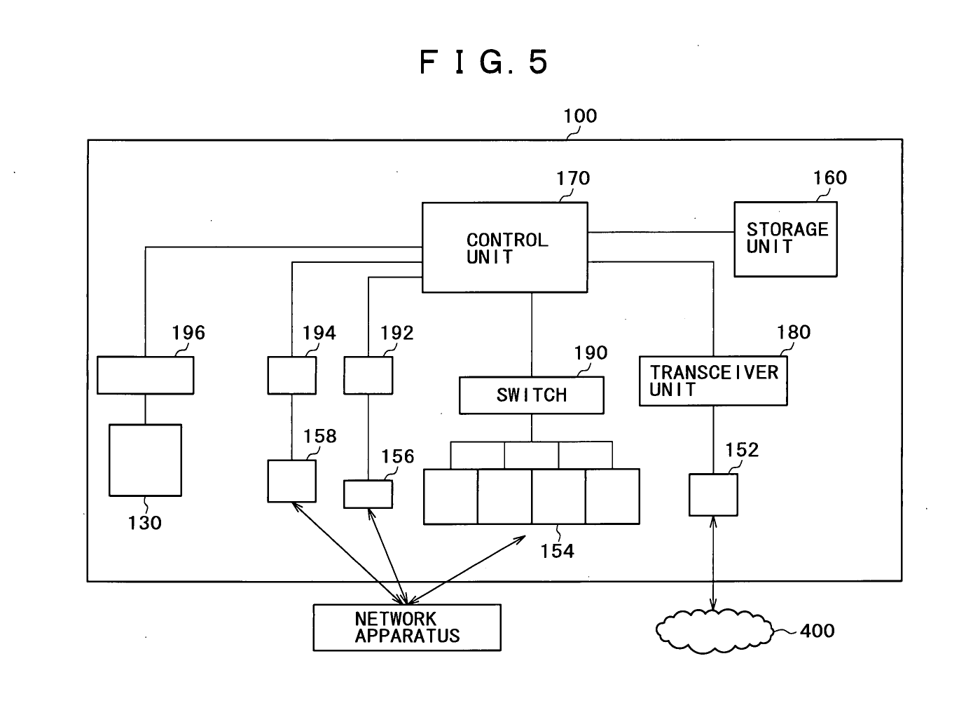

With reference to FIG. 5, the internal structure of the AV router 100 will be described below.

FIG. 5 is a schematic block diagram showing the internal structure of the AV router 100, and components not shown in FIG. 5 can be designed in any way.

The AV router 100 includes a storage unit 160, a control unit 170, a transceiver unit 180 connected to the WAN-side port 152, a switch 190 to change the routes of LAN-side ports 154, a USB controller 192 to control the flat-shaped USB port 156, another USB controller 194 to control the square USB port 158, and a slot controller 196 to control the slot 130.

(Transceiver Unit 180)

The transceiver unit 180 has the function of sending signals and the function of receiving signals and sends and receives signals to and from the network 400 through the WAN-side port 152. The transceiver unit 180 sends the ID number stored in the storage unit 160 to the authentication server 200. The transceiver unit 180 sends a demand for confirmation of whether there is an updated file of the firmware or not and a demand for the updated file, if any, to the updating server 300, too. These pieces of information to be sent are peculiar to the present embodiment. The transceiver unit 180 receives information about authentication (for example, passwords) from the authentication server 200 and information about whether there is an updated file or not and the updated file, if any, from the updating server 300.

(Storage Unit 160)

The unique ID number of the AV router 100 and firmware for prescribed control are stored in the storage unit 160. The control unit 170 controls the AV router 100 by running the firmware.

The AV router 100 of the present embodiment is characterized by the ID number and the firmware both stored in the storage unit 160. The ID number and the firmware will be described below.

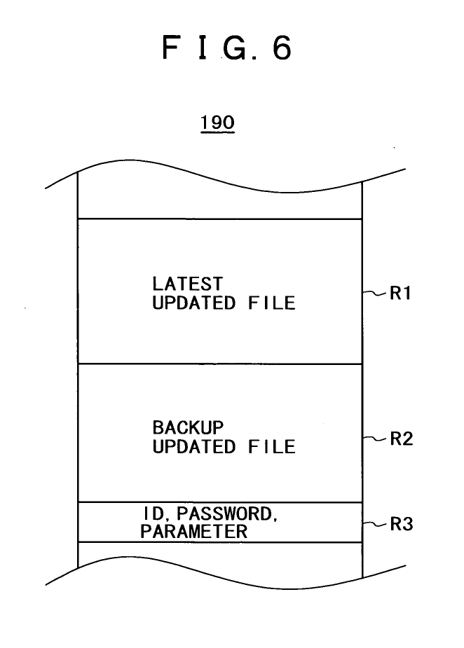

FIG. 6 is an illustration of the concept of the storage area of the storage unit 160.

The storage area of the storage unit 160 is imaginarily divided into the first, second, and third areas R1, R2, and R3.

The firmware latest to the AV router 100 is stored in the first area R1. The “latest firmware” means the updated file obtained at the time of the last update of the firmware and is not necessarily the latest from the viewpoint of the updating server 300. In other words, if the latest firmware in the AV router 100 differs from the latest firmware in the updating server 300, the update of the firmware is necessary.

Spare firmware (a backup updated file) is stored in the second area R2. While the firmware in the first area R1 is being updated, it may be damaged. If it happens, the spare firmware comes into use. For example, before an AV router 100 is shipped from the factory, the same firmware as in the first area R1 may be stored in the second area R2 as spare firmware. In this case, if the firmware in the first area R1 is damaged, the spare firmware in the second area R2 starts when the AV router 100 reboots.

Stored in the third area R3 are various kinds of information such as the ID number of the AV router 100, information (the date of update, file size, information about the version, etc.) about the firmware stored in the first area R1, and other parameters. Allotment of ID numbers to AV routers 100 may be made in accordance with any standards so long as any number is not allotted to two or more AV routers 100. Information about the ID numbers of AV routers 100 is registered with the authentication server 200. Because the above various kinds of information may be rewritten, it has to be recorded in a rewritable storage medium. However, as ID numbers are normally not supposed to be rewritten, they can be recorded in an unrewritable storage medium.

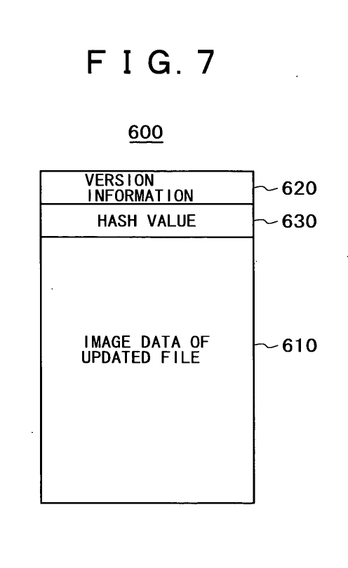

With reference to FIG. 7, updated files to be provided from the updating server 300 will be described below. FIG. 7 is an illustration of the concept of an updated file 600 to be provided from the updating server 300. As shown in FIG. 7, the updated file 600 includes the image data 610 of the updated file 600, various kinds of information 620 such as information about the version, and the hash value 630 of the image data 610. The hash value 630 is the image data 610 which has been mixed up and compressed into certain lengths (for example, 128 bits). Hashing procedure is opened to the public, and the functions of MD5, MASH, and SHA-1 are commonly used. Efficiency can be raised by signing the hash value 630 (short data) of the image data 610 instead of the image data 610 (long data) of the updated file 600.

It is preferable to encode the updated file 600 and then send it out. Such encoding can be made by using the public key system or the secret key system (common key system). The security of the system is improved because the updated file 600 can be encoded and then sent out through the network 400 to AV routers 100 by using such technique.

The AV router 100 of the present embodiment is constructed as described above. Now, an authentication server 200 and an updating server 300, which are also components of the router management system of the embodiment, will be described.

(Authentication Server 200)

Being based on a unique ID number sent from the AV router 100, the authentication server 200 authenticates the AV router 100. The authentication meant here is to check if the AV router 100 having sent the ID number is the one which can receive an updated file of the firmware from the updating server 300. Information about the ID numbers and passwords of AV routers 100 is registered with the authentication server 200, for example, before the AV routers 100 are shipped from the factory.

When having authenticated the AV router 100, the authentication server 200 issues a password to the AV router 100. This password is the one with which the AV router 100 demands the updated file of the firmware from the updating server 300.

The password issued to the AV router 100 by the authentication server 200 may be a one-time password. A one-time, or throwaway, or dynamic, password can be used only once. Even if a one-time password leaks out to a third party, damage would be minimal because it cannot be used repeatedly.

The authentication server 200 has the function of encoding the password and sending it. Such encoding can be made by using the public key system or the secret key system (common key system) Thus, the security of the system is improved.

Further, the updating server 300 sends the authentication server 200 an inquiry about whether the authentication server has authenticated the AV router 100 or not. Then, the authentication server 200 sends a reply to the updating server 300. This way, the updating server 300 directly refers to the authentication server 200, further improving the security of the system.

(Updating Server 300)

The updating server 300 is the server managing updated files of the firmware that the AV router 100 can use. The updating server 300 manages, for example, the updated files according to their versions. Further, the updating server 300 may organize a database of the information as to which AV router 100 has which version's updated file and hold such information.

In response to an inquiry about the presence or absence of an updated file, the updating server 300 sends a reply to the AV router 100. If there is an updated file, after the AV router 100 being authenticated by the authentication server 200, the updating server 300 may immediately provide the AV router 100 with the updated file. Alternatively, the updating server 300 may inquire of the AV router 100 accessing it whether the AV router 100 needs the updated file of the firmware.

The updating server 300 has the function of encoding the updated file of the firmware and sending it. Such encoding can be made by using the public key system or the secret key system (common key system). Thus, the security of the system is improved.

The updating server 300 sends the authentication server 200 an inquiry about whether the authentication server 200 authenticated the AV routers 100 or not. Accordingly, correctness of the AV router 100 which demanded the updated file can be reliably checked and the security of the system is improved.

The updating server 300 can provide the network apparatus (in FIG. 1, the computer 500) connected to the AV router 100, too, with the updated file of the firmware. In this case, the format of the updated file held by the AV router 100 can be the same as the format of the updated file held by the network apparatus 500 connected to the AV router 100.

According to the present embodiment, as described above, with the time-managing function of the AV router 100, times of many AV routers' access to the updating server 300 is dispersed; therefore, the scale of the updating server 300 can be reduced.

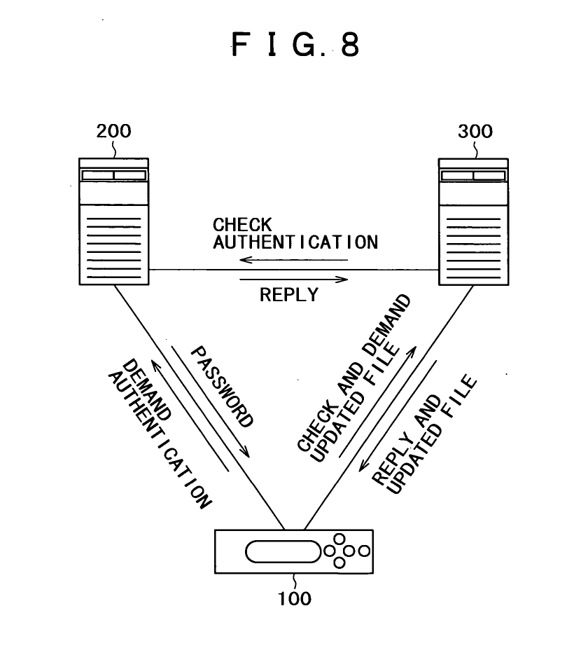

So far, the system configuration of the router management system 10 according to the embodiment has been described. Next, with reference to FIG. 8, the communication among the components will be described.

(Communication Between AV Router 100 and Authentication Server 200)

As shown in FIG. 8, the following communication is carried out between the AV router 100 and the authentication server 200.

The AV router 100 demands authentication from the authentication server 200.

The authentication server 200 authenticates the AV router 100

The authentication server 200 communicates with the AV router 100, informing that it has been authenticated. On this occasion, the authentication server 200 issues, for example, a password to indicate than the AV router 100 has been authenticated. The password is preferably a one-time password, or throwaway, or dynamic, password which can be used only once. Even if a one-time password leaks out to a third party, damage would be minimal because it cannot be used repeatedly.

(Communication Between AV Router 100 and Updating Server 300)

As shown in FIG. 8, the communication between the AV router 100 and the updating server 300 is carried out as follows:

The AV router 100 demands information about the presence or absence of an updated file from the updating server 300. On this occasion, authentication of the AV router 100 is not required.

The updating server 300 provides the AV router 100 with information about the presence or absence of an updated file.

The AV router 100 demands the updated file from the updating server 300. This time, the AV router 100 has to be authenticated. Therefore, as described above, the AV router 100 sends the updating server 300, for example, a password, etc. indicating that the AV router 100 is authenticated by the authentication server 200.

The updating server 300 sends the updated file to the AV router 100.

(Communication Between Updating Server 300 and Authentication Server 200)

As shown in FIG. 8, the communication as follows is carried out between the updating server 300 and the authentication server 200.

When demanded an updated file by the AV router 100, the updating server 300 inquires of the authentication server 200 about the authentication of the router 100.

The authentication server 200 sends a reply about the authentication of the AV router 100 to the updating server 300.

It is preferable that the above-described communication between the apparatus is carried out by using SSL (Secure Sockets Layer). SSL is technique to secure the data exchanged between WWW browsers and WWW servers and a protocol to realize encoding and authenticating functions in the socket level. Wire tapping can be prevented by ascertaining that the WWW server on the other side is authentic and by encoding data before transmission.

Further, according to the present embodiment, as described above, subjects to be sent and received are also encoded. Security can be further improved by, for example, encoding an updated file of the firmware sent from the updating server 300 to the AV router 100, an ID number sent from the AV router 100 when authentication is carried out by the authentication server 200, a password sent from the authentication server 200 to the AV router 100, and so on.

(Method of Managing Network Apparatus)

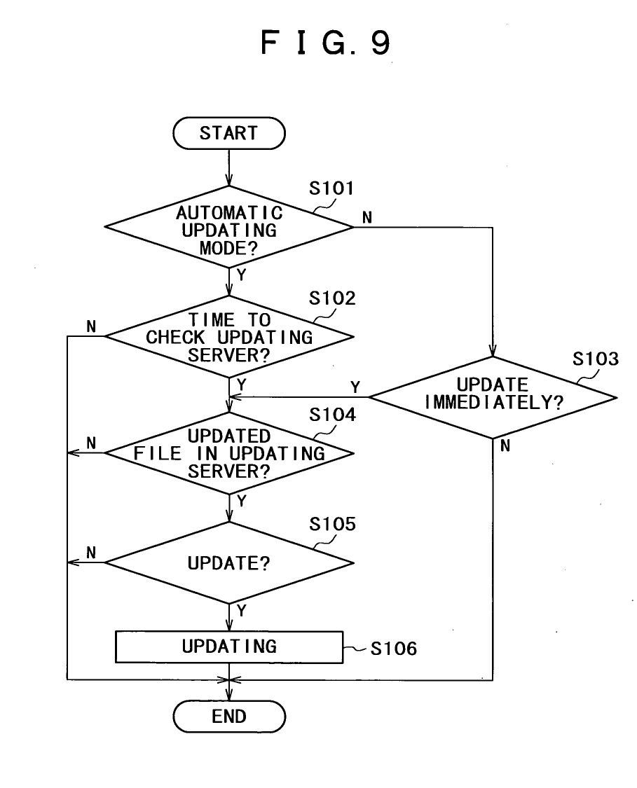

Referring to a flowchart shown in FIG. 9, a method of managing AV routers 100 by the router management system 10 of the present invention will be described.

When the AV router 100 is turned on, first, the AV router finds whether the updating mode of the firmware is automatic or manual (Step S101).

The AV router 100 finds whether or not it is time to ascertain the presence or absence of an updated file in the updating server 300 if the updating mode is automatic in Step S101 (Step S102). The timing of ascertaining the presence or absence of the updated file is, as described above, prescribed for each AV router 100, and it can be fixed as every 24 hours, for example.

The updating is ended if the updating mode is manual in Step S101 and the AV router 100 is not to ascertain immediately whether there is an updated file of the firmware server or not (Step S103).

The AV router 100 accesses the updating server 300 if it is time to ascertain the presence or absence of an updated file in Step S102 or if the AV router 100 is to ascertain immediately whether there is an updated file in the updating server or not in Step S103. At this stage, authentication of the AV router 100 by the updating server 300 is not required, and the AV router 100 ascertains whether there is an updated file in the updating server 300 or not (Step S104). If no updated file is found in the updating server 300, the updating is ended.

If there is an updated file in the updating server 300, the updating server 300 inquires of the AV router 100 accessing it whether it needs the updated file or not (Step S105). The updating is ended if the AV router 100 does not need the updated file. Further, the system may be configured such that when the updating server 300 has an updated file, Step S105 is skipped and the updating server 300 immediately sends the updated file to the AV router 100.

When the AV router 100 needs the updated file, the AV router 100 demands authentication from the authentication server 200 and further the AV router 100 demands the updated file from the updating server 300 (Step S106).

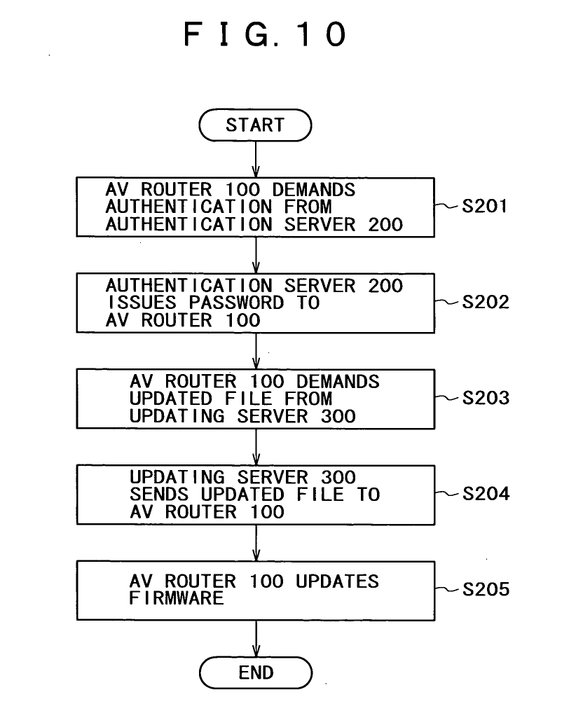

With reference to FIG. 10, the processing when the AV router 100 needs the updated file will be described.

First, the AV router 100 demands authentication from the authentication server 200 (Step S201). The authentication server 200 authenticates the AV router 100 by checking its unique ID number. The AV router 100 may actively transmit its ID number when it demands authentication from the authentication server 200. Alternatively, the authentication server 200 may obtain the ID number of the AV router 100 in response to the demand for authentication from the AV router 100.

When the authentication server 200 has authenticated the AV router 100, the authentication server 200 issues the AV router 100 a password indicating that the AV router 100 has been authenticated (Step S202). On the other hand, when the authentication server 200 failed to authenticate the AV router 100, the authentication server 200 informs the AV router 100 of it and ends the authentication process.

After being authenticated by the authentication server 200 and having obtained a password, the AV router 100 uses the password and demands an updated file from the updating server 300 (Step S203).

Having received the demand for the updated file from the AV router 100, the updating server 300 checks to see that the password is correct and sends the updated file to the AV router 100 (Step S204). Further, the updating server 300 may check with the authentication server 200 as to whether it has actually authenticated the AV router 100 demanding the updated file.

When provided with the updated file by the updating server 300, the AV router 100 updates its firmware (Step S205).

As described above, according to the present embodiment, because each AV router 100 connecting the computer 500 and the network 400 has its unique ID number, each AV router 100 can cooperate with the authentication and updating servers 200, 300 for its authentication and the updating of its firmware without involving the computer 500 in the processing. Unlike the prior art, it is not necessary for the user to download an updated file into his computer 500 through the AV router 100 and then upload the updated file from his computer into the AV router 100. Accordingly, even inexperienced users can easily update the firmware of the AV routers.

Besides, the firmware of the AV router 100 can be updated in real time if the power of the AV router 100 is always kept on; thus the firmware is always kept in the newest condition.

(Second Embodiment)

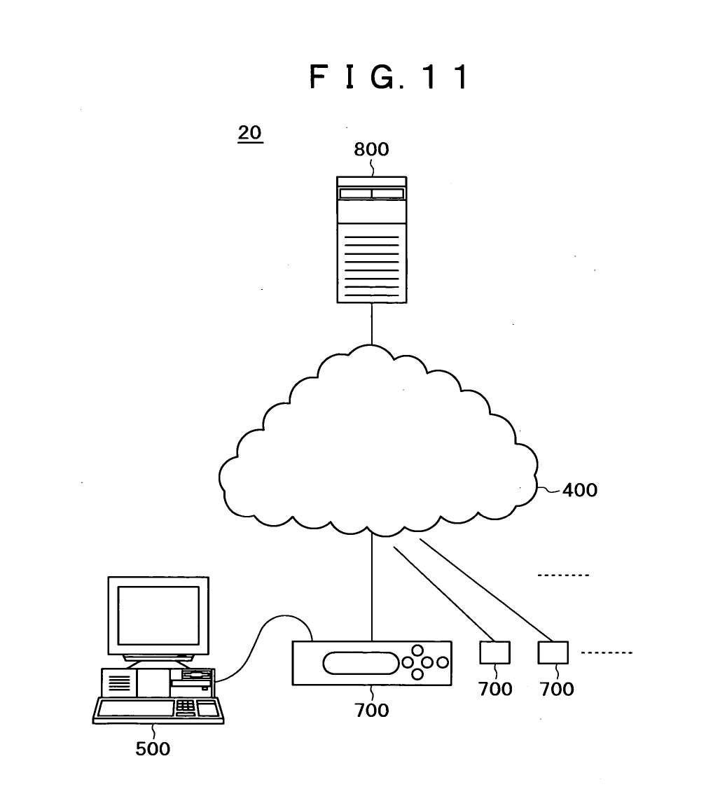

In the first embodiment, the case where system components include the AV router 100, the authentication server 200 and the updating server 300 has been described. In a router management system 20 according to the present embodiment, as shown in FIG. 11, system components include an AV router 700 as a relay to be managed, a computer 500 as network apparatus connected to the AV router 700, and an updating server 800 which authenticates the AV router 700 and provides the AV router 700 with an updated file of its firmware. In the present embodiment, such a router management system 20 will be described.

Since the AV router 700 is substantially the same as the AV router 100 in the first embodiment, the repetitive description is omitted.

(Updating Server 800)

The updating server 800 of the present embodiment has both the functions of the updating server 300 and authentication server 200 of the first embodiment.

The updating server 800 authenticates the AV router 700 by checking its ID number sent from the AV router 700 and provides the authenticated AV router 700 with an updated file of the firmware. Authentication of the AV router 700 by the updating server 800 is substantially the same as the authentication of the AV router 100 by the authentication server 200 in the first embodiment. Further, the provision of the updated file of the firmware to the AV router 700 by the updating server 800 is substantially the same as the provision of the updated file of the firmware to the AV router 100 by the updating server 300 in the first embodiment.

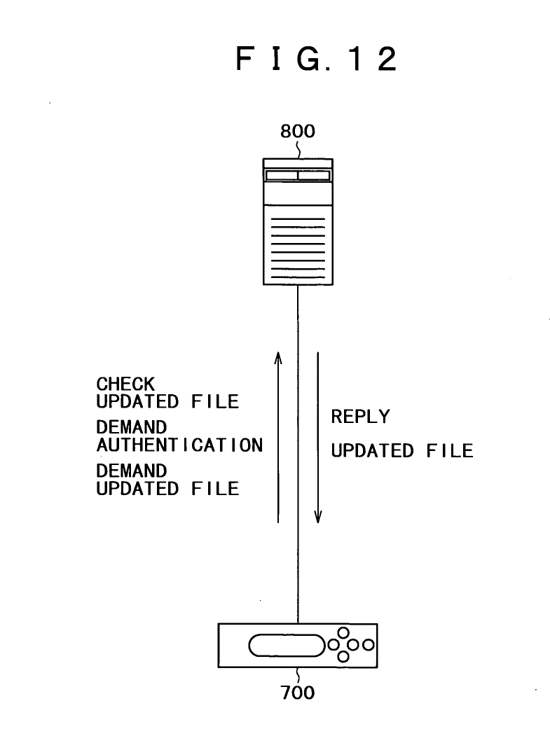

Now, with reference to FIG. 12, communication between the components will be described.

(Communication Between AV Router 700 and Updating Server 800)

Following transactions are carried out between the AV router 700 and the updating server 800.

The AV router 700 demands information about the presence or absence of an updated file from the updating server 800. On this occasion, authentication of the AV router 700 is not required.

The updating server 800 provides the AV router 700 with information about the presence or absence of an updated file.

The AV router 700 demands the updated file from the updating server 800. On this occasion, authentication of the AV router 700 is required.

The AV router 700 demands authentication from the updating server.

The updating server 800 authenticates the AV router 700 which demanded authentication.

The updating server 800 provides the AV router 700 with the updated file.

(Method of Managing Network Apparatus)

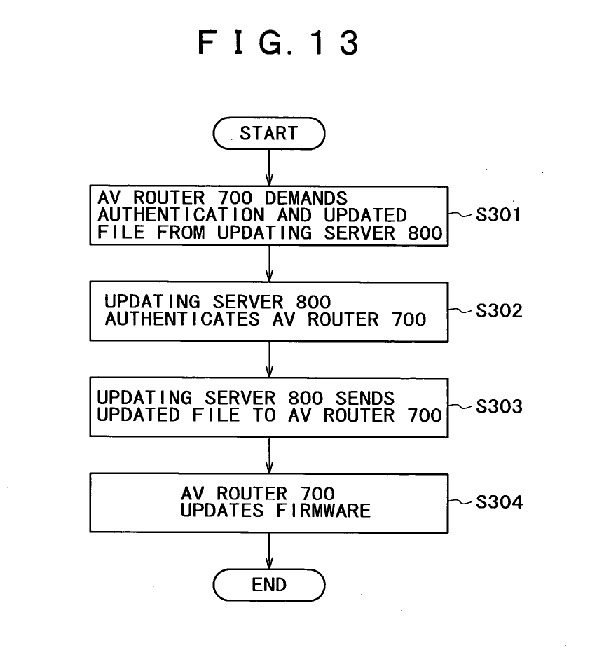

Next, with reference to a flowchart shown in FIG. 13, a method of managing the AV routers by the router management system 20 of the present embodiment will be described. Since Steps S101 to S105 described in the first embodiment by referring to FIG. 9 and Steps in the present embodiment are substantially the same, the repetitive description is omitted here.

With reference to FIG. 13, the processing when the AV router 700 needs the updated file in Step S106 of FIG. 9 will be described.

First, the AV router 700 demands authentication and an updated file from the updating server 800 (Step S301). This authentication is made by using a unique ID number of the AV router 700. The AV router 700 may actively transmit its ID number when it demands authentication from the authentication server 200. Alternatively, the authentication server 800 may obtain the ID number of the AV router 700 in response to the demand for authentication from the AV router 700.

When the updating server 800 has authenticated the AV router 700 (Step S302), the updating server 800 sends an updated file to the AV router 700 (Step S303).

Upon receiving the updated file from the updating server 800, the AV router 700 updates the firmware (Step S304).

As described above, according to the present embodiment, because each AV router 700 connecting the computer 500 and the network 400 has a unique ID number, each AV router 700 can cooperate with the updating server 800 for its authentication and the updating of the firmware without involving the computer 500 in the processing. Therefore, unlike the prior art, it is not necessary for the user to download an updated file into the computer 500 through the AV router 700 and then upload the updated file from the computer 500 into the AV router 700. Accordingly, even inexperienced users can easily update the firmware of the AV routers.

With reference to the attached drawings, we have described preferred embodiments of the management system of relays for network apparatus, the relay for the network apparatus, the authentication server, the updating server, and the method of managing relays for the network apparatus. However, it is to be understood that the invention is not limited to the specific embodiments thereof and it is further understood by those skilled in the art that various changes and modifications may be made in the light of the above teachings without departing from the spirit and scope of the subjoined claims.

What is claimed is:

1. A management system to manage relays for connecting network apparatus to a network, the system comprising:
a plurality of relays, each relay having a unique identification number, provided with firmware for prescribed control, having one or a plurality of network apparatus connected to it, and connecting said network apparatus to said network;
an authentication server to authenticate the relays by checking their identification numbers through the network; and
an updating server to provide the authenticated relays with an updated file of the firmware through the network, the relays accessing the updating server automatically to ascertain whether there is an updated file of the firmware in the updating server or not.

2. A management system to manage relays for connecting network apparatus to a network, the system comprising:
a plurality of relays, each relay having a unique identification number, provided with firmware for prescribed control, having one or a plurality of network apparatus connected to it, and connecting said network apparatus to said network; and
an updating server to authenticate the relays by checking their identification numbers through the network and provide the authenticated relays with an updated file of the firmware through the network, the relays accessing the updating server automatically to ascertain whether there is an updated file of the firmware in the updating server or not.

3. A relay having one or a plurality of network apparatus connected to it and connecting said network apparatus to a network, the relay comprising:
a storage unit wherein a unique identification number of the relay and firmware for prescribed control is stored;
a control unit to do the prescribed control by running the firmware;
a transmitting unit to transmit the identification number of the relay through said network for the authentication of the relay; and
a receiving unit to receive an updated file of the firmware through the network after the authentication of the relay.

4. A relay as defined in claim 3, wherein the control unit accesses automatically an updating server for providing the relay with an updated file of the firmware and ascertains whether there is an updated file of the firmware in the updating server or not.

5. A relay as defined in claim 4, wherein the control unit has a time-managing function.

6. A relay as defined in claim 5, times of relays' access to the updating server being dispersed by their time-managing functions.

7. A relay as defined in claim 3, wherein the control unit accesses an authentication server for the authentication of the relay, the server checking the identification number to authenticate the relay.

8. A relay as defined in claim 7, wherein the control unit has the function of encoding the identification number and transmitting the encoded identification number.

9. A relay as defined in claim 3, wherein the storage unit has:
a first storage area wherein the updated file of the firmware received at the last updating is stored; and
a second storage area wherein an updated file before the updated file stored in the first storage area is stored.

10. A relay as defined in claim 3, further comprising:
a display unit to show various kinds of information; and
an operating unit for the user to operate the relay.

11. A relay as defined in claim 3, further comprising a slot to hold a removable means of memory.

12. An authentication server which authenticates relays with unique identification numbers by checking the identification numbers, each relay having firmware for prescribed control and one or a plurality of network apparatus connected to it, connecting said at least one network apparatus to a network, and transmitting its identification number to the authentication server for authentication.

13. An authentication server as defined in claim 12, which issues a password for the authenticated relays to demand an updated file of the firmware from an updating server after authenticating the relays.

14. An authentication server as defined in claim 13, wherein the password is a one-time password.

15. An authentication server as defined in claim 13, which has the function of encoding the password and transmitting the encoded password.

16. An authentication server as defined in claim 12, the updating server sending the authentication server an inquiry about whether the authentication server authenticated the relays or not, the authentication server sending a reply to the updating server.

17. An updating server which provides relays with an updated file of their firmware though a network after an authentication server authenticates the relays by checking their identification numbers, each relay having a unique identification number, firmware for prescribed control, and one or a plurality of network apparatus connected to it and connecting said network apparatus to the network.

18. An updating server as defined in claim 17, which has the function of encoding the updated file of the firmware and transmitting the encoded updated file.

19. An updating server as defined in claim 17, which provides the network apparatus, too, with the updated file of the firmware.

20. An updating server as defined in claim 17, which sends the authentication server an inquiry about whether the authentication server authenticated the relays or not.

21. An updating server as defined in claim 17, which inquires of the relays accessing the server whether the relays need the updated file or not.

22. An updating server which (i) authenticates relays with unique identification numbers by checking the identification numbers, each relay having firmware for prescribed control and one or a plurality of network apparatus connected to it, connecting said network apparatus to a network, and transmitting its identification number to the updating server for authentication, and (ii) provides the authenticated relays with an updated file of the firmware though the network.

23. An updating server as defined in claim 22, which has the function of encoding the updated file and sending the encoded updated file.

24. An updating server as defined in claim 22, which provides the network apparatus, too, with the updated file of the firmware.

25. An updating server as defined in claim 22, which inquires of the relays accessing the server whether the relays needs the updated file of the firmware or not.

26. A method of managing a plurality of relays in a system which comprises (i) the plurality of relays, each relay having a unique identification number, provided with firmware for prescribed control, having one or a plurality of network apparatus connected to it, and connecting said at least one network apparatus to a network, (ii) an authentication server to authenticate the relays by checking their identification numbers through the network, and (iii) an updating server to provide the authenticated relays with an updated file of the firmware through the network, the method comprising:
a first step wherein the relays access the updating server to ascertain whether there is an updated file of the firmware in the updating server or not;
a second step wherein if the relays need the updated file, they demand authentication from the authentication server;
a third step wherein the authentication server authenticates the relays and issues a password to them;
a fourth step wherein the relays demand the updated file from the updating server by using the password; and
a fifth step wherein the updating server checks to see that the password is correct and sends the updated file to the relays.

27. A method as defined in claim 26, in the first step of which the relays (i) ascertain whether the updating mode of the firmware is automatic or manual, (ii) find whether or not it is time to ascertain the presence or absence of an updated file if the updating mode of the firmware is automatic, and (iii) access the updating server if it is time to ascertain the presence or absence of an updated file or if the updating mode is manual and they are to ascertain immediately whether there is an updated file in the updating server or not.

28. A method as defined in claim 26, whose second step includes a sub-step wherein if there is an updated file in the updating server, the updating server inquires of the relays accessing it whether they need the updated file or not.

29. A method of managing a plurality of relays in a system which comprises (i) the plurality of relays, each relay having a unique identification number, provided with firmware for prescribed control, having one or a plurality of network apparatus connected to it, and connecting said network apparatus to a network and (ii) an updating server to authenticate the relays by checking their identification numbers through the network and provide the authenticated relays with an updated file of the firmware through the network, the method comprising:
a first step wherein the relays access the updating server to ascertain whether there is an updated file of the firmware in the updating server or not; and
a second step wherein the updating server authenticates the relays and sends the updated file to the relays.

30. A method as defined in claim 29, in the first step of which the relays (i) ascertain whether the updating mode of the firmware is automatic or manual, (ii) find whether or not it is time to ascertain the presence or absence of an updated file if the updating mode is automatic, and (iii) access the updating server if it is time to ascertain the presence or absence of an updated file or if the updating mode is manual and they are to ascertain immediately whether there is an updated file in the updating server or not.

31. A method as defined in claim 29, whose second step includes a sub-step wherein if there is an updated file in the updating server, the updating server inquires of the relays accessing it whether they need the updated file or not.
